(19) United States
(12) Patent Application Publication
(10) Pub. No.: US 2008/0289489 A1
(43) Pub. Date: Nov. 27, 2008

(54) Composite Piston Unit and Automatic Vehicle Transmission

(76) Inventors: Jan Brosch, Bargteheide (DE); Michael Boehm, Koberg (DE); Roland Kral, Seevetal (DE); Jan Suhr, Ratzeburg (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/112,168

(22) Filed: Apr. 30, 2008

(30) Foreign Application Priority Data
May 24, 2007 (DE) DE102007024 522.1

(51) Int. Cl. F04B 9/00; F16J 9/00

(52) U.S. Cl. 92/138; 277/434

(57) ABSTRACT

A composite piston unit (10) for an automatic vehicle transmission, in particular a double clutch transmission, comprises a shift rod and a control piston provided at each end of the shift rod and designed to run in a respective cylinder, wherein each control piston comprises a carrier and an elastomeric sealing element bonded to the periphery of the carrier thus forming a composite system. Each control piston is securely connected with respectively one end of the shift rod and is designed to have an axial extent of less than 0.25 relative to its diameter.

The invention relates to a composite piston unit and an automatic vehicle transmission comprising a composite piston unit.

A composite piston unit is known for example from DE 103 08 206 A1. Here, the control pistons are designed to run freely in the cylinder. The shift rod is displaceably mounted in the cylinder by means of separate sliding bearings arranged at its ends. The control pistons have on their outer circumference an inner radial seal on the pressure side and an outer radial seal on the pressure-less side of the control piston. A sliding guide for guiding the piston extends in the axial direction between the radial seals, wherein the sliding guide must be sufficiently dimensioned to prevent a tipping or tilting of the control piston in the cylinder. The relatively great guide length of the control pistons and the separate sliding bearings of the shift rod result in a considerable axial length.

In the piston unit according to EP 1 164 316 A, the pistons are connected via a snap connection with play with the shift rod. The control pistons have on their outer periphery a sealing element in the form of a grooved ring. For guidance in the cylinder, each piston has a guide section with a considerable axial length.

The object of the invention consists in providing a composite piston unit with reduced axial length and reduced manufacturing expenditure.

The invention achieves this object. The invention has realized that with a fixed connection of the control pistons on the shift rod, the entire piston unit is axially displaceably mounted by means of the control pistons and the control pistons are guided by the shift rod without tilting. A separate mounting of the shift rod is therefore equally dispensable as an axial guide section on the periphery of the control pistons. The axial extent of the control pistons can therefore be reduced considerably according to the invention, with respect to the prior art, to a maximum of 0.25 in relation to the control piston diameter. As a whole, a considerable reduction of the structural expenditure and of the axial overall length of the control piston unit can be achieved.

The control piston diameter here means the mean external diameter of the control piston in the operating state and therefore generally corresponds to the internal diameter of the corresponding cylinder.

Dispensing with an axial guide section on the outer periphery of the control pistons according to the invention is present when the control piston free-running, i.e., without fastening on the shift rod, under usual operating conditions would be subject to a no longer tolerable risk of tilting. This is generally the case with an axial extent of the control piston of less than 0.25, in particular less than 0.20 relative to the control piston diameter.

In a preferred embodiment, the sealing element of the control pistons has a circumferential sealing part on the pressure side, having at least one leakage recess for the venting of the piston and for damping the piston displacement with regard to an improved response behaviour.

In particular in this embodiment, the sealing element, according to a particularly preferred aspect, has a circumferential constriction element, the radial extent of which is expediently less than the radial extent of the sealing part on the pressure side. The constriction element acts as a flow brake or as a dosing element, in order to achieve a controlled and uniform leakage flow over the entire periphery. This aspect is independent of the connection of the control pistons to the shift rod and the axial extent of the control pistons.

The invention may preferably be applied to load shift transmissions, in particular direct-shift gearbox or double clutch transmissions. The invention may generally be applied to automatic or partially automatic transmissions of motor vehicles.

The invention is described below with the aid of advantageous embodiments with reference to the enclosed figures, in which:

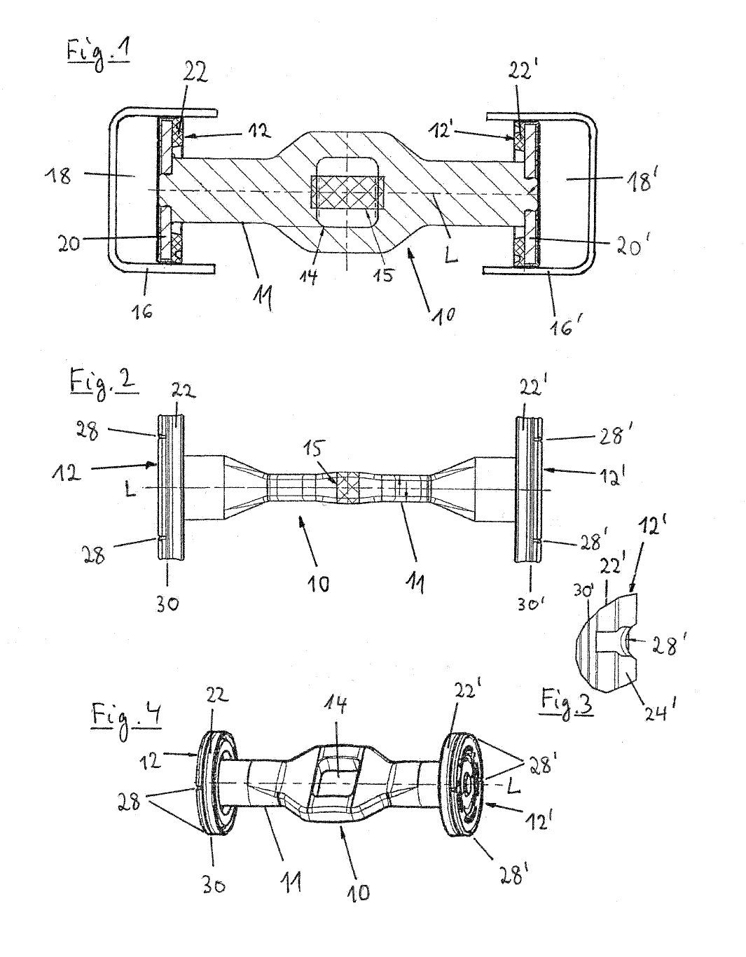

FIG. 1 shows a cross-section through a composite piston unit mounted in cylinders in operation state;

FIG. 2 shows a side view onto a composite piston unit perpendicularly to the cross-sectional view according to FIG. 1;

FIG. 3 shows an enlarged side view according to FIG. 2 onto a control piston in the region of a leakage recess;

FIG. 4 shows a perspective view of a composite piston unit;

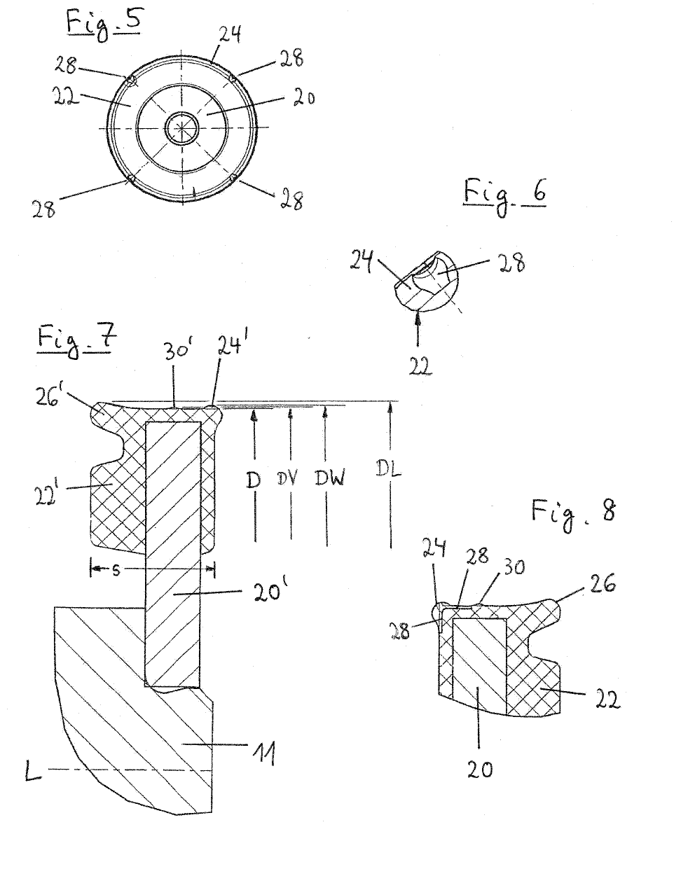

FIG. 5 shows an end-side view onto a composite piston unit;

FIG. 6 shows an enlarged end-side view according to FIG. 5 onto a composite piston unit in the region of a leakage recess;

FIG. 7 shows an enlarged cross-section through a control piston unit; and

FIG. 8 shows an enlarged cross-section through a control piston in the region of a leakage recess.

An automatic transmission for a motor vehicle comprises in accordance with FIG. 1 a control piston unit 10 with a shift rod 11 and respectively a control piston 12, 12′ on the ends of the shift rod 11. The shift rod 11 has in its central part an opening 14 for engaging a shifting element 15.

Each control piston 12, 12′ is mounted so as to be axially displaceable in an associated cylinder 16, 16′. Axial refers here to the longitudinal axis L of the control piston unit 10 or the shift rod 11. The cylinders 16, 16′ can be formed for example by cylindrical inserts in housing bores. Each control piston 12, 12′ delimits on its end side a corresponding pressure chamber 18, 18′ in the respective cylinder 16, 16′. An axial displacement of the shift rod 11 is achieved by applying hydraulic pressure to one of the pressure chambers 18, 18′ and applying pressure-less conditions to the respectively other pressure chamber. Therefore, an axial displacement of the shift rod 11 can be performed in both axial directions.

The control pistons 12, 12′ have respectively a fixed carrier 20, 20′ which is securely connected with the shift rod 11 in a force-fitting, form-fitting and/or inter-material manner, for example by means of a press fit (see FIG. 7), but is in no way restricted to this. The control pistons 12, 12′ and the shift rod 11 can consist of metal, in particular steel, a sufficiently strong plastic or another suitable material.

On their outer periphery the control pistons 12, 12′ have a respective circumferential sealing element 22, 22′, which consists of an elastomeric material, in particular rubber, including thermoplastic elastomer, and is injected onto the respective carrier 20, 20′; this is therefore a composite system, in particular a metal/rubber composite system.

As the entire control piston unit 10 is mounted on both sides via the control pistons 12, 12′, the shift rod 11 itself does not have to have any separate mountings on the end side. In addition, the control pistons 12, 12′ do not have to have an axially extended sliding guide which prevents twisting or tilting of the control pistons 12, 12′ in the cylinders 16, 16′. The carrier 20, 20′ of the control pistons 12, 12′ can therefore be constructed as a comparatively thin disc, in which the mean axial extent s (see FIG. 7) of the control pistons 12, 12′ is comparatively small, for example less than 5 mm in the case of a diameter of 27 mm of the cylinders 16, 16′.

To seal the respective pressure chamber 18, 18′, the sealing element 22, 22′ has a circumferential sealing part on the pressure side in the form of a sealing bead 24, 24′ on the pressure side. The sealing bead 24, 24′ protrudes in its radial extent DW over a mean external diameter D of the control piston 12, 12′ (see FIG. 7), in which the mean external diameter D of the control piston is determined on the outer periphery of the sealing element 22, 22′ and in the operating state is smaller than the internal diameter of the corresponding cylinder 16, 16′. The sealing bead 24, 24′ therefore lies over the periphery of the sealing element 22, 22′ in a sealing manner against the inner wall of the respective cylinder 16, 16′. The operating state differs here from the state under environmental conditions in particular due to the behaviour of the elastomer material.

In order to prevent the penetration of dirt particles into the space between the cylinders 16, 16′ and the sealing elements 22, 22′, the sealing element 22, 22′ preferably comprises a circumferential sealing part, displaced axially to the sealing bead 24, 24′, in the form of a sealing lip 26, 26′ on the pressureless side. The sealing lip 26, 26′ in its radial extent DL likewise protrudes over the mean external diameter D of the control piston 12, 12′ (see FIG. 7) and therefore lies over the periphery of the sealing element 22, 22′ in a sealing manner against the inner wall of the respective cylinder 16, 16′. The radial extent DL of the sealing lip 16, 16′ can be greater here than the radial extent DW of the sealing bead 24, 24′, because the sealing lip 26, 26′ is more flexible than the sealing bead 24, 24′; however, this is not necessarily the case.

In the sealing bead 24, 24′, a plurality of leakage recesses 28, 28′ are provided distributed over the periphery, via which hydraulic oil can flow out from the pressure chamber 18, 18′ in a controlled manner into the space between the sealing element 22, 22′ and the cylinder 16, 16′. Hereby, a venting of the pressure chamber 18, 18′, a lubricating of the sealing element 22, 22′ and an improvement to the response behaviour of the control piston unit 10 by dosed damping is achieved. The number of leakage recesses 28, 28′ over the periphery of the sealing element 22, 22′ and the dimensions thereof are selected in a suitable manner for setting the desired leakage; preferably, preferred is a number in the range of two to six, in particular four leakage openings distributed preferably uniformly over the periphery, see for example FIG. 5.

As can be seen from FIGS. 2, 3 and 8, the leakage recesses 28, 28′ extend axially through the entire sealing bead 24, 24′ on the pressure side, but not through the constriction element 30, 30′ described below and not through the sealing lip 26, 26′ on the pressure-less side. The sealing lip 26, 26′ on the pressure-less side opens in the manner of a non-return valve when the pressure which is exerted by the oil flowing through the leakage openings 28, 28′ exceeds a particular value, in order to allow an outflow of the oil for example into the oil sump.

Axially between the sealing bead 24, 24′ on the pressure side and the sealing lip 26, 26′ on the pressure-less side a circumferential constriction element 30, 30′ is provided, the radial extent DV of which in the operating state is smaller than or equal to the internal diameter of the corresponding cylinder 16, 16′, so that between the constriction element 30, 30′ and the cylinder 16, 16′ in the operating state an annular gap remains which is greater than or equal to zero. The constriction element 30, 30′ reduces the flow cross-section of the oil passing through the leakage recesses 28, 28′ and therefore acts as a flow brake, which further improves the response behaviour of the control piston unit 10 and leads to a more uniform distribution of the oil flow over the entire periphery of the sealing element 22, 22′.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A composite piston unit for an automatic vehicle transmission comprising a shift rod and a control piston provided at each end of the shift rod and designed to run in a respective cylinder, wherein each control piston comprises a carrier and an elastomeric sealing element bonded to the periphery of the carrier thus forming a composite system, wherein each control piston is securely connected with respectively one end of the shift rod and is designed to have an axial extent of less than 0.25 relative to its diameter.

2. The composite piston unit according to claim 1, wherein the shift rod and the control piston provided at each end of the shift rod and designed to run in a respective cylinder are designed to run in a respective cylinder of a double clutch transmission.

3. The composite piston unit according to claim 1, wherein each control piston is designed to have an axial extent of less than 0.20 relative to its diameter.

4. The composite piston unit according to claim 1, wherein each control piston is designed to have an axial extent less than 5 mm.

5. The composite piston unit according to claim 1, wherein the sealing element comprises at least one circumferential constriction element.

6. The composite piston unit according to claim 5, wherein the constriction element is designed to have a radial extent smaller than the radial extent of the sealing element.

7. The composite piston unit according to claim 5, wherein the constriction element is designed to have a radial extent in the operating state smaller than or equal to the internal diameter of the corresponding cylinder.

8. The composite piston unit according to claim 1, wherein the sealing element comprises a circumferential sealing part on the pressure side.

9. The composite piston unit according to claim 8, wherein the circumferential sealing part on the pressure side has at least one leakage recess.

10. The composite piston unit according to claim 1, wherein the sealing element comprises a circumferential sealing part on the pressure-less side.

11. The composite piston unit according to claim 8, wherein the sealing part on the pressure side and/or the sealing part on the pressure-less side is designed to have a radial extent greater than or equal to the internal diameter of the respective cylinder.

12. An automatic vehicle transmission, comprising a composite piston unit with a shift rod and a control piston provided at each end of the shift rod and designed to run in a respective cylinder, wherein each control piston comprises a carrier and an elastomeric sealing element bonded to the periphery of the carrier thus forming a composite system, wherein each control piston is securely connected with respectively one end of the shift rod and is designed to have an axial extent of less than 0.25 relative to its diameter.

13. The automatic vehicle transmission according to claim 12, wherein the automatic vehicle transmission is a double clutch transmission.

14. The automatic vehicle transmission according to claim 12, wherein each control piston is designed to have an axial extent of less than 0.20 relative to its diameter.

15. The automatic vehicle transmission according to claim 12, wherein each control piston is designed to have an axial extent less than 5 mm.

16. The automatic vehicle transmission according to claim 12, wherein the sealing element comprises at least one circumferential constriction element.

17. The automatic vehicle transmission according to claim 16, wherein the constriction element is designed to have a radial extent smaller than the radial extent of the sealing element.

18. The automatic vehicle transmission according to claim 16, wherein the constriction element is designed to have a radial extent in the operating state smaller than or equal to the internal diameter of the corresponding cylinder.

19. The automatic vehicle transmission according to claim 12, wherein the sealing element comprises a circumferential sealing part on the pressure side.

20. The automatic vehicle transmission according to claim 19, wherein the circumferential sealing part on the pressure side has at least one leakage recess.

21. The automatic vehicle transmission according to claim 12, wherein the sealing element comprises a circumferential sealing part on the pressure-less side.

22. The automatic vehicle transmission according to claim 19, wherein the sealing part on the pressure side and/or the sealing part on the pressure-less side is designed to have a radial extent greater than or equal to the internal diameter of the respective cylinder.
